(19) United States
(12) Patent Application Publication
(10) Pub. No.: US 2006/0070445 A1
(43) Pub. Date: Apr. 6, 2006

(54) Mobile test stand for determining the sound insulation or insertion loss of a test object

(76) Inventors: Frank Juber, Leverkusen (DE); Ralph Bungenberg, Dusseldorf (DE); Michael Sulzbacher, Leverkusen (DE); Gerald Dreffke, Koln (DE)

Correspondence Address: WILLIAM COLLARD;COLLARD & ROE, P.C., 1077 NORTHERN BOULEVARD, ROSLYN, NY, 11576, US

(21) Appl. No.: 11/231,623

(22) Filed: Sep. 21, 2005

(30) Foreign Application Priority Data
Sep. 22, 2004 (DE) 10 2004 046 200.3

(51) Int. Cl. G01H 15/00; G01N 29/09

(52) U.S. Cl. 73/571; 73/589

(57) ABSTRACT

The present invention relates to a test stand, particularly a ceiling test stand (1) for determining the sound insulation or insertion loss of a test object (2), particularly a vehicle floor, having a transmission chamber (3), which has multiple sound transmitters (8) and a test opening (4) for positioning the test object (2), and at least one microphone (12), which is positioned outside the transmission chamber, in front of the test opening (4). In order to be able to implement such a test stand in an existing acoustic laboratory facility so it is well integrated and cost-effective, it is suggested that the test stand (1), including the transmission chamber (3), be implemented as a mobile or non-fixed measuring device and have a measuring device or measuring system, which is assigned to the microphone or multiple microphones (12), for determining the sound intensity, the transmission chamber (3) having interior faces running at oblique angles to one another and/or the sound transmitters (8) being activated in such a way that they generate a diffuse sound field in the transmission chamber (3), and the transmission chamber (3) having multilayered walls, which contain at least two different material layers.

The present invention relates to a test stand, particularly a ceiling test stand for determining the sound insulation or insertion loss of a test object, particularly of vehicle floor installations, having a transmission chamber, which has multiple sound transmitters and a test opening for positioning the test object, and at least one microphone, which is positioned outside the transmission chamber in front of the test opening.

Window and ceiling test stands are used for measuring the sound insulation of large components and material installations. These test stands generally comprise a transmission chamber equipped with sound transmitters and a receiving chamber equipped with one or more microphones, a test opening for positioning the test object being implemented from the transmission chamber to the receiving chamber. Window test stands are used for measuring the sound insulation of vertically positioned components and material installations, such as car body dash board coverings, while components and material installations which are positioned essentially horizontally in the intended installation position, such as vehicle floor installations, are tested in ceiling test stands. The reason for the use of these different types of test stands are the different acoustic properties which components and material installations display under the influence of gravity. Thus, for example, in dash board coverings, there is frequently an air gap toward the front wall, which has a significant effect on the air sound insulation and the air sound absorption. In contrast, in carpet floor installations, there is typically no or only a relatively small air gap to the floor sheet metal. Furthermore, the oscillation behaviour of a flat component excited by sound waves is also, in principle, a function of the inclination of the component in relation to the horizontal. Therefore, for example, the determination of the air sound insulation or insertion loss of a carpet floor installations in a window test stand would result in unrealistic results. In general, it may be determined that the actual installation position of the object to be tested in regard to sound insulation or insertion loss has a large influence on the measurement result. The actual installation position is simulated through the measurement in a window or ceiling test stand.

The transmission chamber and the receiving chamber of conventional ceiling test stands are rooms of a fixed building erected in reinforced concrete construction. The internal volume of the transmission chamber, which is typically located in the basement of the building, is more than 60 m³ in this case, for example. The internal volume of the neighboring receiving chamber is in the same order of magnitude. The test opening for positioning the test object (test item) is left open in the ceiling of the transmission chamber and/or in the floor of the receiving chamber and is approximately 6 to 8 m² in size, for example. Because of the complex construction and the large amount of space required for conventional ceiling test stands, their integration in an existing acoustic laboratory facility is typically difficult and causes high costs.

The present invention is based on the object of providing a test stand of the type cited at the beginning, which may be integrated well in an existing acoustic laboratory facility and may be implemented cost-effectively.

This object is achieved according to the present invention in that the test stand, including the transmission chamber, is implemented as a mobile or non-stationary measuring device and has a measuring device or measuring system, assigned to the microphone or multiple microphones, for determining the sound intensity, wherein the transmission chamber having interior faces running at oblique angles to one another and/or the sound transmitters being activated in such a way that they generate a diffuse sound field in the transmission chamber, and wherein the transmission chamber having multilayered walls, which contain at least two different material layers.

Thanks to its non-stationary or mobile and therefore accordingly small embodiment, the test stand according to the present invention may be integrated easily and cost-effectively into an existing acoustic laboratory environment. The use of the intensity measuring technique allows precise and reproducible determination of the sound insulation or insertion loss of a test object in this case, even if high interference levels exist, and without having to take the environmental influences into consideration through corrections. The test stand according to the present invention is therefore as independent as possible from the particular measuring environment.

The space required for the test stand according to the present invention, which has a width of preferably less than 3 m, particularly less than 2.5 m, is less than 15 m³, particularly less than 12 m³ for example.

For the mobility of the test stand, the transmission chamber is preferably mounted on a chassis, particularly a wheeled chassis. However, it is also within the scope of the present invention to transport the test stand to a desired usage location using a suitable separate conveyor if necessary, particularly a mobile floor conveyor, such as a forklift. For this purpose, at least one recess and/or feet may be provided below the transmission chamber, which allow a fork or another load carrier of a conveyor to be positioned below the transmission chamber.

In order to always ensure stable mounting of the test stand, it is also suggested that the chassis or the feet be implemented like a three-point support, whose support points are positioned at the corners of a triangle.

The installation of a test screen carrying the test object has been shown to be relatively complex in conventional ceiling test stands. To improve and/or ease the installation, according to a further embodiment of the present invention, at least one quick-action clamping device is attached to the outside of the transmission chamber, in an edge region of the test opening, for attaching a test screen carrying the test object. Thus, the test screens may be replaced easily and rapidly.

A further preferred embodiment of the test stand according to the present invention is that each of its sound transmitters, such as broadband loudspeakers, is assigned its own noise generator and each noise generator is assigned its own amplifier. This embodiment allows excitation of a diffuse sound field having multiple sound sources which are not correlated to one another, particularly a sound field having a frequency range from at least 315 Hz, preferably from at least 200 Hz, the microphone(s) positioned outside the transmission chamber being selected for and capable of receiving a corresponding frequency range.

The floor and the walls of the transmission chamber are constructed as multilayered according to the present invention. A wall construction in which the walls are constructed from multiple wood plates, at least one sand layer delimited by two wood plates, and at least one foam or textile fiber layer positioned between two wood plates, has been shown to be especially advantageous.

To generate a diffuse sound field, the transmission chamber has interior faces running at oblique angles to one another. The thickness of the sand layer located between the wood plates may decrease from the floor of the transmission chamber to the test opening. Such a wall construction counteracts a flanking transmission, which would impair the measurement result, if the complete test opening is used. The problems connected with a possible flanking transmission are additionally overcome by the intensity measurement technique used in the test stand according to the present invention.

Further preferred and advantageous embodiments of the test stand according to the present invention are specified in the subclaims.

In the following, the present invention will be explained in greater detail on the basis of a drawing illustrating multiple exemplary embodiments.

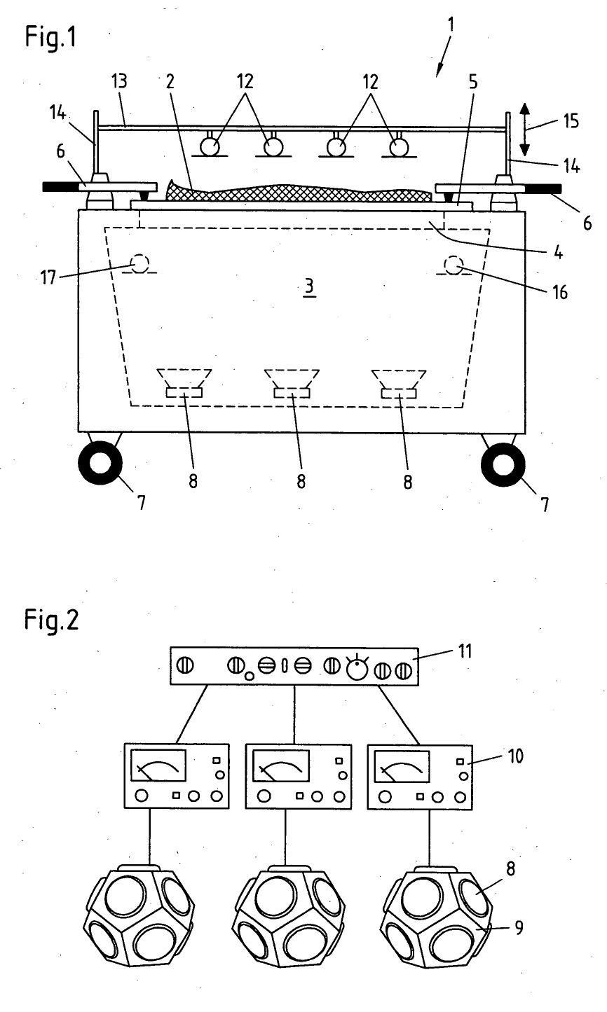

FIG. 1 shows a schematic illustration of a mobile ceiling test stand in a side view;

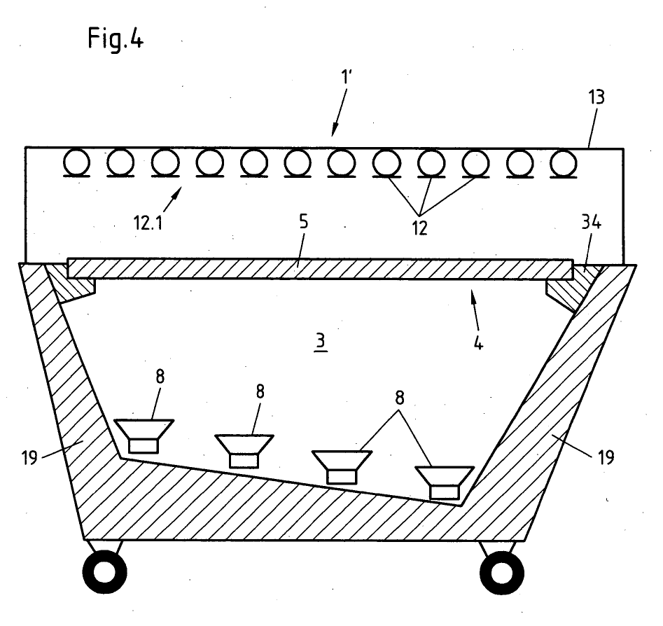

FIG. 2 shows a schematic illustration of multiple sound transmitters, noise generators, and a signal amplifier comprising multiple output stages, which are used in a test stand according to the present invention as shown in FIG. 1 or FIG. 4;

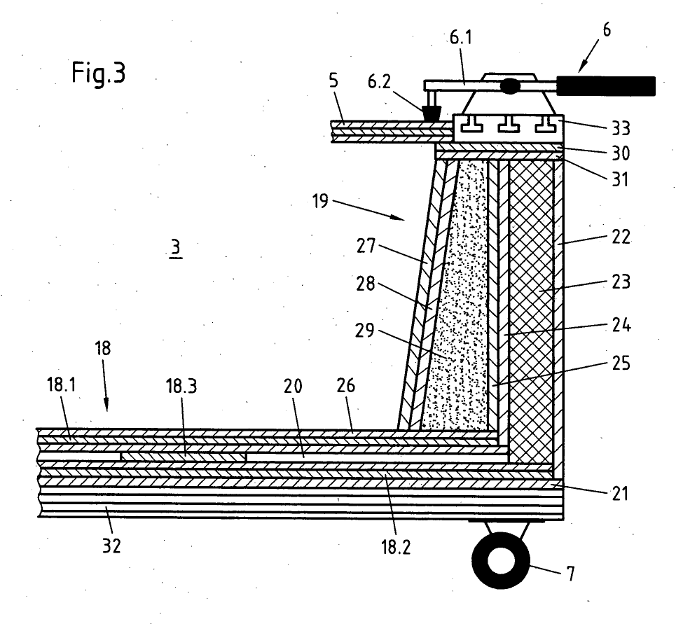

FIG. 3 shows a schematic illustration of a detail of a mobile ceiling test stand in a longitudinal sectional view; and

FIG. 4 shows a schematic illustration of a mobile ceiling test stand according to a further exemplary embodiment in a longitudinal sectional view.

The ceiling test stand 1 illustrated in FIG. 1 is used for determining the sound insulation or insertion loss of a test object 2, particularly a complete passenger chamber floor of a motor vehicle having carpeting lying loose thereon or attached thereto. The ceiling test stand 1 is implemented as a mobile measuring device. It has an essentially closed transmission chamber 3, which is provided on top with a window-like test opening 4, which may be closed by a separate test screen 5, having the test object 2 attached thereto, to form a seal. Multiple quick-action clamping devices 6 for the sealed attachment and/or pressing of the test screen 5 against the outside of the transmission chamber 3 are attached in the edge region of the test opening 4.

The transmission chamber 3 is mounted on a chassis. The chassis preferably comprises three or four rubber-tired wheels 7. The wheels of the chassis having three wheels form a three-point support, at least one wheel 7 being implemented so it is pivotable around a vertical axis for steering the chassis. In the chassis comprising four wheels, at least two wheels 7 are accordingly steerable and/or pivotable.

Multiple sound transmitters and/or loudspeakers 8, which are not correlated with one another, are installed in the transmission chamber 3. The sound transmitters may, for example, be broadband loudspeakers which are mounted in a loudspeaker housing 9 having the shape of a rhombic dodecahedron (compare FIG. 2). Each of the loudspeakers 8 has its own noise generator 10 assigned to it, which is in turn provided with its own output stage 11 and/or its own signal amplifier. The loudspeakers 8 generate a diffuse sound field in the transmission chamber 3. The implementation of a diffuse sound field is supported by an oblique-angled orientation of the transmission chamber walls to one another and in relation to the transmission chamber floor.

One or more microphones 12 are positioned in front of the test opening 4 and/or the test object 2 outside the transmission chamber 3. The microphones 12 are attached to a carrier 13, which is preferably mounted on the ceiling and/or the walls of the transmission chamber 3. However, it is also possible to attach the microphone(s) 12 to a separate carrier (not shown), which is supported on one or more stands (not shown) or the like positioned beside the transmission chamber 3. In the exemplary embodiment illustrated in FIG. 1, the microphones 12 are attached to a crossbeam 13 which bridges the test opening 4. The crossbeam 13 is in turn mounted on vertical supports 14. A distance of the crossbeam 13 and therefore the microphones 12 from a reference plane spanned by the test opening 4 may be set continuously in the directions of the double arrow 15.

In addition, the microphone row may also be displaced perpendicularly to the plane of the drawing, i.e., horizontally and/or transversely to the double arrow 15. Furthermore, the distance of the microphones 12 to one another may be set continuously. Instead of an essentially one-dimensional microphone row, a two-dimensional microphone array may also be installed on the crossbeam 13 and/or the supports 14. The external dimensions of the test stand 1 according to the present invention are approximately 3 m×2.3 m×1.4 m, for example (length×width×height).

As is obvious from FIG. 1, the test stand 1 according to the present invention does not have a closed, permanently assigned receiving chamber, as is the case in conventional, stationary ceiling test stands. The test stand 1 according to the present invention may rather be moved and/or transported into different measuring chambers, the measuring chambers each preferably being implemented as low-reflection measuring chambers, so that the measurement on the receiving side is performed in a low-reflection environment.

Furthermore, the ceiling test stand 1 according to the present invention comprises a measuring device or measuring system (not shown) for determining the sound intensity. The sound intensity is established by measuring the sound pressures at two positions situated at a specific distance Δr from one another using at least one microphone 12. The sound pressure p is obtained from the mean value of the two microphone signals and the sound particle velocity v is obtained from the approximated pressure gradients Δp/Δr between the two microphones 12 and/or microphone positions:
v=Δp/(2πf ρ Δr),
in which f stands for the frequency and ρ for the density.

The sound intensity at any arbitrary point of the sound field may be determined from the product of the two sound field variables p and v determined using measurement technology. Through multiplication of the sound intensity with the associated areas on which the sound intensity was measured, the sound power and/or the sound power level may finally be determined.

The essential advantage of using the intensity measuring technique is that the sound power and/or the sound power level of a sound source may be determined with high interference levels present. In particular, the intensity measuring technique allows the determination of the sound power level even in semi-diffuse fields without having to consider spatial influences through corrections. In addition, by measuring the sound intensity, which is a vector variable, the localization of main noise sources of a noise source is also allowed, since the flow direction of the sound may be localized through positive and/or negative maximum deflection.

Within the transmission chamber 3, the sound power and/or the sound power level output by the sound transmitters 8 is measured using a movable microphone 16 or multiple stationary microphones 16, 17. A rotating microphone boom (not shown) or the like may be positioned in the transmission chamber 3 for moving a single microphone 16.

The sound insulation of the test object 2 and/or the sound insulation proportion may be determined from the ratio of the sound power level in the transmission chamber 3 to the sound power level measured and/or determined on the receiving side.

FIG. 3 shows a section of the transmission chamber 3 of a ceiling test stand according to the present invention in a longitudinal sectional view. In contrast to FIG. 1, the sound transmitters are not shown here for reasons of clarity.

It may be seen that the transmission chamber 3 has a multilayered floor 18 and multilayered walls 19. The test screen 5 is also constructed as multilayered. The floor 18 is produced from multiple wood plates, which are each multiplex beech plates, for example. A smaller wood plate 18.3, which defines an air gap 20 as a spacer between two wood plate stacks 18.1 and 18.2, is positioned between an upper stack 18.1 made of three wood plates and a lower stack 18.2 made of three wood plates. The lowermost wood plate 21 projects laterally in relation to the two wood plates above it by approximately the thickness of a vertical wood plate 22 (side plate).

The external wood plate 22 is followed toward the inside first by a porous sound absorbing material 23, which consists of an 80 mm thick foam layer, for example, particularly a polyurethane foam slab. Instead of a foam layer or as a supplement thereto, a textile fiber layer, such as a cotton nonwoven material layer, may be used. Two wood plates 24, 25 lying one on top of another adjoin this layer 23, of which one wood plate (24) is mounted on the lower plate of the upper wood plate stack 18.1 of the floor 18. The lower plate of the upper wood plate stack 18.1 projects laterally in relation to the two wood plates above it by approximately the thickness of the vertical wood plate 24 for this purpose. The other wood plate 25, positioned in the wall interior, is supported on the uppermost wood plate 26 of the floor 18.

Two wood plates 27, 28 lying on top of one another, which are positioned at a distance to the two wood plates 24, 25 lying in the wall interior and delimit a cavity with these, form the inner completion of the wall 19. The cavity is filled up with sand 29, preferably with quartz sand. Quartz sand having a grain size of 0.1 to 0.5 mm has been shown to be especially suitable, the mean grain size being approximately 0.24 mm. The reverberant wood plates 27, 28 delimiting the transmission chamber 3 are positioned diagonally and/or obliquely in relation to the other, essentially vertically positioned wood plates 22, 24, 25 of the wall 19, so that the thickness of the sand layer 29 decreases from the bottom to the top. The mean thickness of the sand layer 29 is approximately 30 mm, for example.

Two essentially horizontally positioned wood plates 30, 31 lying on one top of another, which rest tightly on the upper edges of the wood plates 22, 24, 25, 27, 28 and define the test opening of the test stand, form the upper completion of the wall 19. The inner edge of the upper wood plates 30, 31 terminates essentially flush with the wood plate 27 delimiting the transmission chamber 3 in this case, so that the size of the test opening is maximized. The size of the test opening may be approximately 2.7 m×1.8 m, for example.

The transmission chamber 3 and/or test stand 1 is provided with a chassis which comprises profiled carriers 32 on which rollers in the form of rubber-tired wheels 7 are mounted, for example.

Profiled carriers 33 are also mounted on the upper wood plate 30, which are used for the formfitting attachment of quick-action clamps 6, using which the test screen 5 carrying the test object may be clamped and/or pressed against the upper wood plate 30 to form a seal. The quick-acting clamps 6 engage in a formfitting way in undercut longitudinal grooves of the particular profiled carrier 33 and may thus be displaced along the profiled carrier 33, so that their position is variably adjustable. The quick-action clamps 6 each have a lockable clamping lever 6.1 in the exemplary embodiment shown, which is provided with an angled clamping head 6.2 on its end facing toward the test opening. The clamping head 6.2 is preferably produced from a rubber-elastic material.

A peripheral seal is provided in the contact area of the test screen 5 on the transmission chamber 3 and/or on the outside of the transmission chamber 3. The seal consists of a ring seal assigned to the edge area of the test screen 5, for example. The ring seal may be manufactured from cell rubber or another sealing and vibration-decoupling material. In addition or alternatively, one or more peripheral grooves may be implemented in the upper wood plate 30 and/or the test screen 5, in each of which a peripheral, elastic rubber profiled seal is received, which projects above the top of the wood plate 30 and/or the bottom of the test screen 5.

A further exemplary embodiment of a ceiling test stand according to the present invention is schematically illustrated in FIG. 4. The ceiling test stand 1′ is again implemented as a mobile measuring device. The transmission chamber 3, which is positioned on a wheeled chassis, is equipped with multiple sound transmitters (loudspeakers) 8 and has essentially reverberant internal faces running at oblique angles to one another, so that a diffuse sound field arises in the transmission chamber. The horizontal width of the transmission chamber 3 increases continuously from its lowest point in the direction toward the upper test opening 4. An annular insert 34, which is externally implemented as correspondingly diagonal, presses against the upper inner edge of the walls 19, which run diagonally downward toward one another. The insert 34 has a peripheral shoulder, in which a plate-shaped test screen 5 having a test object (not shown) is inserted in a formfitting way to produce a seal.

A two-dimensional microphone array 12.1 or a microphone row mounted on a crossbeam movable perpendicularly to the plane of the drawing is positioned outside the transmission chamber 3. The microphone array 12.1 or the microphone row is connected to a measured data collection device (not shown), which relays the measured data recorded using the microphones 12 to a computer (not shown) provided with analysis software for spatial transformation of sound fields. The spatial transformation of sound fields (STSF) is a measuring technology for determining three-dimensionally induced sound fields of structures, which are able to oscillate, on the basis of discrete sound pressure measurements using a microphone array or a movable microphone row. The spatial transformation of sound fields is based on the known cross-spectrum method. A goal of the spatial transformation of sound fields is the location of local partial sound sources on emitting structure surfaces.

The sound pressure is measured at discrete points in a two-dimensional plane parallel to the test object surface via the microphone array 12.1 or the microphone row 12. The cross-spectrum method requires at least one reference signal. The reference signal is used for the purpose of assigning the sound pressure recorded by the microphone to a specific test object via a coherence analysis. It is thus possible to filter out incoherent sound. The spatial transformation of sound fields is therefore independent of acoustic interference sources. In particular, acoustic variables, particularly the sound pressure, may be used as the reference signal. The measured data is collected using a measured data collection device and relayed to the analysis software.

The implementation of the present invention is not restricted to the exemplary embodiments described above. Rather, further variations are possible, which, even with significantly different designs, make use of the idea according to the present invention given in the claims. Thus, for example, instead of a chassis, recesses or feet may be provided below the transmission chamber 3 which allow the transport of the non-stationary test stand using a conveyor, e.g., a forklift or a crane truck. Furthermore, lifting elements may be attached to the top of the test stand for fastening transport cables or the like.

On the receiving side, instead of multiple microphones 12, only one single microphone 12 may be positioned for manual scanning of the test object 2.

Furthermore, there is also the possibility of implementing the mobile test stand 1, 1′ according to the present invention as a window test stand having a vertically positioned test opening 4.

1. A test stand, particularly a ceiling test stand (1, 1′), for determining the sound insulation or insertion loss of a test object (2), having a transmission chamber (3), which has multiple sound transmitters (8) and a test opening (4) for positioning the test object (2), and at least one microphone (12), which is positioned outside the transmission chamber, in front of the test opening (4), wherein the test stand (1, 1′), including the transmission chamber (3), is implemented as a mobile or non-stationary measuring device and has a measuring device or measuring system, assigned to the microphone or multiple microphones (12), for determining the sound intensity, the transmission chamber (3) having interior faces running at oblique angles to one another and/or the sound transmitters (8) being activated in such a way that they generate a diffuse sound field in the transmission chamber (3), and the transmission chamber (3) having multilayered walls (19), which contain at least two different material layers (22-29).

2. The test stand according to claim 1, wherein at least one quick-action clamping device (6) for attaching a test screen (5) carrying the test object (2) is attached to the outside of the transmission chamber (3), in the edge region of the test opening (4).

3. The test stand according to claim 1 wherein each sound transmitter (8) has its own noise generator (10) assigned to it.

4. The test stand according to claim 3, wherein each noise generator (10) has its own amplifier (11) assigned to it.

5. The test stand according to one claim 1, wherein the sound transmitters (8) emit sound in a frequency range from at least 315 Hz and the microphone or the microphones (12) record a corresponding frequency range.

6. The test stand according to claim 1, wherein the sound transmitters (8) emit sound in a frequency range from approximately 200 Hz and the microphone or the microphones (12) record a corresponding frequency range.

7. The test stand according to claim 1, wherein at least one microphone (16), which may be positioned at different points of the transmission chamber (3), and/or multiple stationary microphones (16, 17) are situated in the transmission chamber (3).

8. The test stand according to claim 1, wherein a microphone array (12.1) facing toward the test opening (4) or a microphone row (12) facing toward the test opening (4), which is movable on a crossbeam (13), is positioned outside the transmission chamber (3).

9. The test stand according to claim 8, wherein the microphone array (12.1) or the microphone row is attached to a holder (13), which allows the distance between a reference plane spanned by the test opening (4) and the microphone (12) to be set.

10. The test stand according to claim 8, wherein the microphone array (12.1) or the microphone row is connected to a measured data collection device, which relays measured data to a computer equipped with analysis software for spatial transformation of sound fields.

11. The test stand according to claim 1, wherein the transmission chamber (3) is mounted on a chassis.

12. The test stand according to claim 1, wherein the walls (19) of the transmission chamber (13) are constructed from multiple wood plates (22, 24, 25, 27, 28), at least one sand layer (29) delimited by two wood plates (25, 28), and at least one foam or textile fiber layer (23) positioned between two wood plates (22, 24).

13. The test stand according to claim 12, wherein the thickness of the sand layer (29) decreases from the bottom toward the top.

14. The test stand according to claim 1, wherein its required space at a width of less than 3 m, preferably less than 2.5 m, is less than 15 m³, particularly less than 12 m³.

15. The test stand according to claim 1, wherein at least one recess and/or feet are provided below the transmission chamber (3), which used for positioning a load carrier of a conveyor below the transmission chamber.

16. The test stand according to claim 11, wherein the chassis or the feet are implemented like a three-point support, whose support points are positioned at the corners of a triangle.

17. The test stand according to claim 1, wherein it does not have a closed receiving chamber which is permanently assigned to the transmission chamber (3).
